(19) United States
(12) Patent Application Publication
(10) Pub. No.: US 2007/0101348 A1
(43) Pub. Date: May 3, 2007

(54) Shaft adjusting device for optical pickup unit

(75) Inventor: Yuan Hung Chang, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/401,364

(22) Filed: Apr. 11, 2006

(30) Foreign Application Priority Data
Oct. 28, 2005 (TW) 094137813

(51) Int. Cl. G11B 7/00

(52) U.S. Cl. 720/673

(57) ABSTRACT

The present invention relates to a shaft adjusting device for an optical pickup unit, which is provided on a loader of an optical disc drive and near one end of the shaft. The present shaft adjusting device comprises a spring, a first locking element, and a second locking element. The spring is fixed on the loader for supporting the end of the shaft and has a first hook portion extendedly formed from one end thereof. The first locking element is disposed on the loader and clamps the end of the shaft with the spring. The second locking element passes through the first hook portion and is locked into the loader for fixing the spring on the loader.

This Non-provisional application claims priority under 35 U.S.C. §119(a) on Patent Application No(s). 094137813 filed in Taiwan, Republic of China on Oct. 28, 2005, the entire contents of which are thereby incorporated by reference.

### FIELD OF THE INVENTION

The present invention relates to a shaft adjusting device for an optical pickup unit, and more particularly to a shaft adjusting device of which assembly is simple and production cost is decreased.

### DESCRIPTION OF RELATED ART

Please refer to FIGS. 1 and 2. FIG. 1 is an exploded view showing a conventional shaft adjusting device for an optical pickup unit, and FIG. 2 is a partly enlarged view showing the conventional shaft adjusting device shown in FIG. 1.

As FIG. 1 shows, an optical pickup transmission structure of a conventional optical disc drive mainly comprises an optical pickup module 1 used for reading data on an optical disc, a driving motor set (not shown in the figure) for driving the optical pickup module 1, a pair of shafts 11, 11 used for mounting and guiding the optical pickup module 1, and a loader 20 used for mounting a spindle motor 21 and the shafts 11, 11. The operation of the transmission structure is as follows: the driving motor set installed at one side of the loader 20 drives the optical pickup module 1 to move it along the shafts 11, 11 to and fro so as to read data stored on the optical disc.

In the optical disc drive, the laser beam emitted from the optical pickup module 1 is more perpendicular to the surface of the optical disc, the reading accuracy is better. As the optical pickup module 1 is mounted on the shafts 11, 11, after the drive is assembled, the height of the end portion of the shaft 11 is adjusted by a shaft adjusting device to make sure that the laser beam emitted from the optical pickup module 1 is perpendicular to the surface of the optical disc.

The conventional shaft adjusting device, as FIG. 2 shows, is installed on the loader 20 adjacent to the end of the shaft 11. The structure of the conventional shaft adjusting device mainly comprises a leaf spring 22 and a screw 23. One end of the leaf spring 22 is fixed on the loader 20 and another end thereof is a free end used for supporting the end of the shaft 11. The screw 23 is fixed on the loader 20 and used for locking the shaft 11 on the loader 20 so that the end of the shaft 11 is clamped between the screw 23 and the leaf spring 22. The height of the end of the shaft is adjusted by screwing the screw 23 up or down.

However, the leaf spring 22 is easily over-pressed by screwing the screw 23 into the loader 20 too much. The elastic fatigue of the leaf spring 22 will happen, and the leaf spring 22 will lose its function to clamp the end of the shaft 11 with the screw 23. Relatively, the reading accuracy of the optical disc drive is bad.

In order to solve the elastic fatigue problem of leaf spring, the leaf spring 22 is replaced with a coil spring. Please refer to FIG. 3. FIG. 3 is a partly exploded view showing a conventional shaft adjusting device using a coil spring.

The end of the shaft 11 is clamped by a coil spring 30 and the screw 23. In order to fix the coil spring 30 on the loader 20, an additional mounting element 201 is installed on the loader 20. The mounting element 201 has a through hole 202, and the coil spring 30 is placed in the through hole 202. According to the conventional shaft adjusting device using the coil spring, the component number increases and the assembly cost and time increase too.

Therefore, how to fix a spring stably on a loader without increasing the number of components and the assembly costs is a topic on which the present invention makes an effort.

### SUMMARY OF THE INVENTION

One object of the present invention is to provide a shaft adjusting device for an optical pickup unit, which can effectively adjust the hieght of the end of the shaft through a simple structure, and number of elements is reduced owing to the simple structure so that the costs and the time for manufacturing and assembly can be lowered down.

For attaining the object mentioned above, the present invention proposes a shaft adjusting device for an optical pickup unit, which is installed on a loader of an optical disc drive and near the end of a shaft, and comprises a spring, a first locking element, and a second locking element. The spring is fixed on the loader for supporting the end of the shaft and has a first hook portion extendedly formed from one end thereof. The first locking element is disposed on the loader and clamps the end of the shaft with the spring. The second locking element passes through the first hook portion and is locked into the loader for fixing the spring on the loader.

According to the preferred embodiment of the present invention, it can further comprise an auxiliary positioning structure. The auxiliary positioning structure is a raised block disposed on the loader and near the end of the shaft, the outer diameter of the block is matched with the inner diameter of the spring, and the spring is put around the raised block so as to fix the spring on the loader more stably.

As mentioned above, the auxiliary positioning structure can be a second hook portion formed extendedly from the end of the first hook portion and is hooked in the first locking element to further position the spring on the loader more stably.

According to the preferred embodiment of the present invention, a sleeve for receiving the first locking element in and out is further disposed on the loader, and the second hook portion also can be hooked in the sleeve.

According to the preferred embodiment of the present invention, when the first locking element is locked into the loader and presses the shaft, the shaft in turn presses the spring to deform the spring and lower the end of the shaft. When the first locking element is screwed out of the loader, the end of the shaft is ascended through the elastic force of the spring. Therefore, the height of the end of the shaft is controlled by the locked depth of the first locking element in the loader, and furthermore, the laser beam emitted from the optical pickup unit can be normal to the surface of the optical disc to ensure the best reading quality of the optical pickup unit.

### BRIEF DESCRIPTION OF THE DRAWINGS

The present invention can be more fully understood by reference to the following description and accompanying drawings, in which:

FIG. 1 is an exploded view showing a conventional shaft adjusting device for an optical pickup unit;

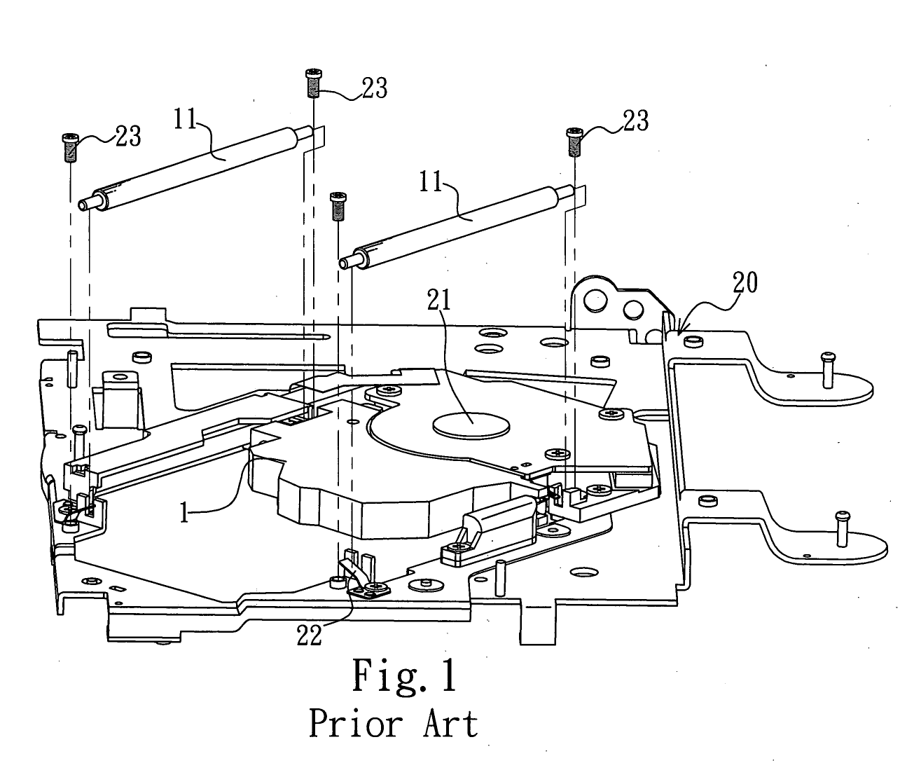

FIG. 2 is a partly enlarged perspective view showing the conventional shaft adjusting device shown in FIG. 1;

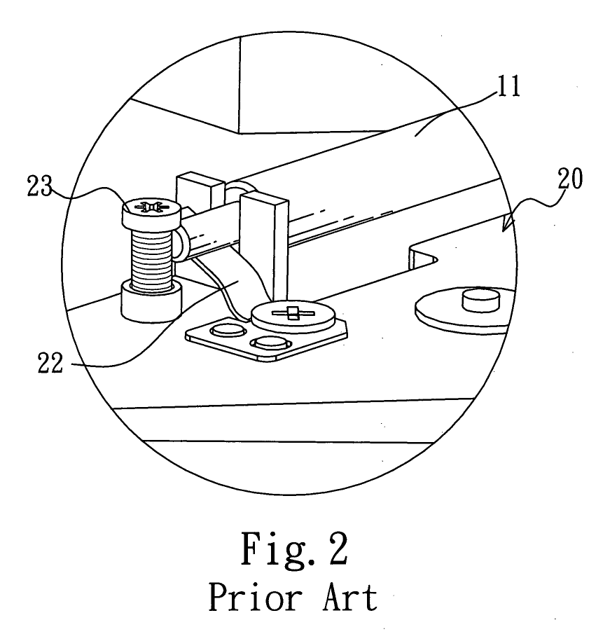

FIG. 3 is a partly enlarged exploded view showing another conventional shaft adjusting device for an optical pickup unit;

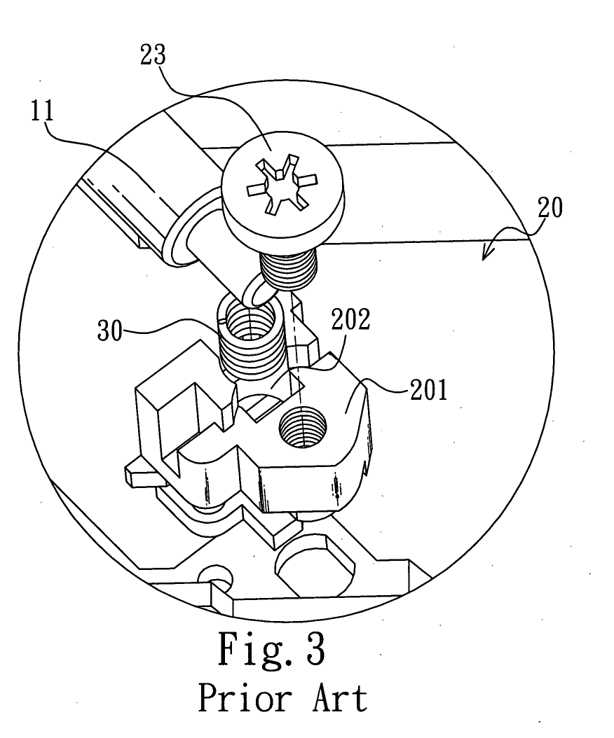

FIG. 4 is an exploded view showing a shaft adjusting device for an optical pickup unit according to a first preferred embodiment of the present invention;

FIG. 5 is a partly enlarged exploded view showing the shaft adjusting device of FIG. 4;

FIG. 6 is a partly enlarged perspective view showing the shaft adjusting device of FIG. 4;

FIG. 7 is a partly enlarged exploded view showing a shaft adjusting device for an optical pickup unit according to a second preferred embodiment of the present invention; and

FIG. 8 is a partly enlarged exploded view showing a shaft adjusting device for an optical pickup unit according to a third preferred embodiment of the present invention.

### DETAILED DESCRIPTION OF THE PREFERRED EMBODIMENTS

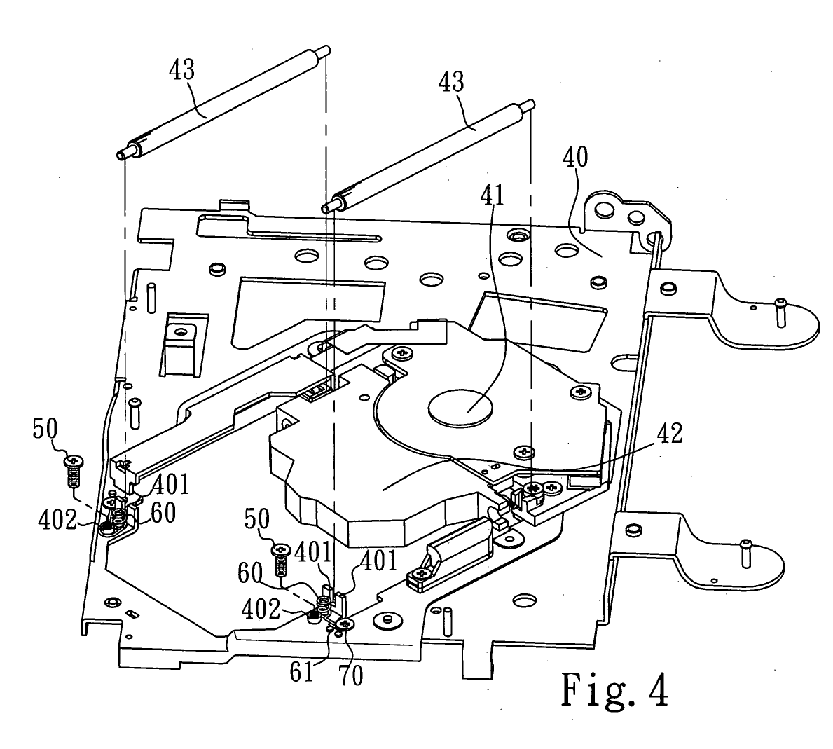

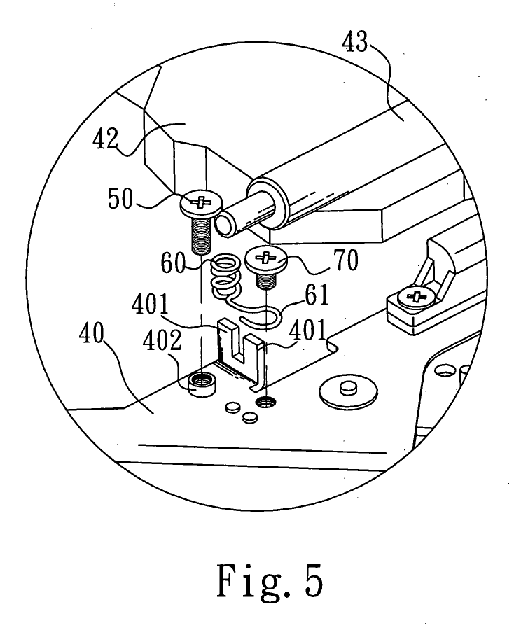

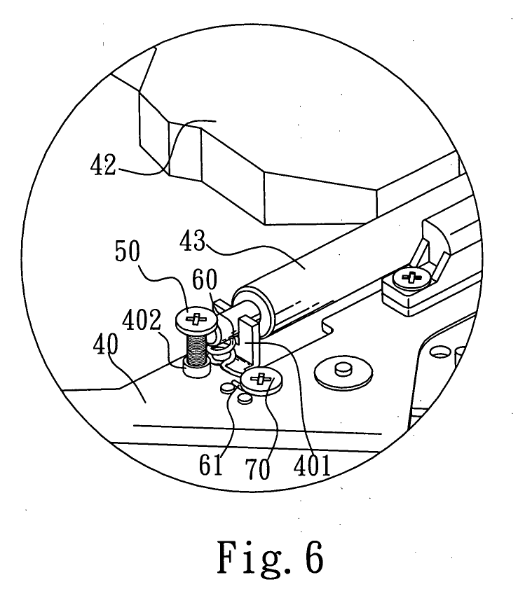

Please refer to FIGS. 4, 5 and 6. FIG. 4 is an exploded view showing a shaft adjusting device for an optical pickup unit according to a first preferred embodiment of the present invention. FIG. 5 is a partly enlarged exploded view showing the shaft adjusting device of FIG. 4. FIG. 6 is a partly enlarged perspective view showing the shaft adjusting device of FIG. 4.

As FIGS. 4, 5 and 6 show, the present invention provides a shaft adjusting device for an optical pickup unit, in which a spindle motor 41 and an optical pickup module 42 are installed on a loader 40. Two shafts 43 are respectively installed at two sides of the optical pickup module 42. The optical pickup module 42 is mounted and moved on the shafts 43 and slid on the loader 40 to read the data on an optical disc. Moreover, a pair of ribs 401 is protruded on the loader 40 at a position near at least one end of the shaft 43 and integrated formed with the loader 40. The end of shaft 43 is placed between and restrained by the ribs 401. The shaft adjusting device of the first preferred embodiment of the present invention is installed on the loader 40 at a position near at least one end of the shaft 43. Alternatively, the shaft adjusting devices can be installed on the loader 40 in one or more places near one or two ends of each shaft 43. The shaft adjusting device is used for adjusting the height of the end of shafts 43 relative to the loader 40 to allow a laser beam emitted from the optical pickup module 42 to be perpendicular to the surface of the disc.

The shaft adjusting device comprises a first locking element 50, a spring 60, and a second locking element 70, in which the first locking element 50 is fixed on the loader 40 and used for pressing the end of the shaft 43, and a sleeve 402 for receiving the first locking element 50 in or out is provided on the loader 40. The sleeve 402 is integrated formed with the loader 40.

The spring 60 is installed on the loader 40 near one end of the shaft 43. The spring 60 is placed under the end of the shaft 43 (as FIG. 6 shows) and clamps the end of the shaft 43 with the first locking element 50. One end of the spring 60 is further extendedly formed with a first hook portion 61; and the second locking element 70 is disposed on the loader 40 and passes through the first hook portion 61 so as to fix the spring 60 on the loader 40. When the first locking element 50 is locked into the loader 40, the end of the shaft 43 is pressed by the first locking element 50 to press the spring 60 and lower its height. Moreover, when the first locking element 50 is screwed out of the loader 40, the elastic force of the spring 60 props up against the end of shaft 43 and lifts the end of shaft 43, and the height of the end of shaft 43 is, therefore, increased.

Please refer again to FIGS. 5 and 6, according to the first preferred embodiment of the present invention, when assembling the shaft 43 on the loader 40, the spring 60 is first placed on the loader 40 at a position near the end of the shaft 43. Thereafter, the second locking element 70 is passed through the first hook portion 61 of the spring 60 to fix the spring 60 on the loader 40. Then, the end of the shaft 43 is placed between ribs 401 and on the spring 60. Finally, the first locking element 50 is locked into the sleeve 402 and clamps the end of the shaft 43 with the spring 60.

After assembling, when the first locking element 50 is further locked into the sleeve 402, it can press the shaft 43 down to deform the spring 60, and the height of the end of shaft 13 is decreased. Alternatively, when the first locking element 50 is screwed out from the sleeve 402, the spring 60 props up against the shaft 43 and increases the height of the end of shaft 43. Whereby, the effect for adjusting the height of the end of the shaft 43 can be attained. Therefore, by means of the first hook portion 61 formed extendedly from the spring 60, the present invention can effectively attain the purpose for fixing the spring 60 without additional components.

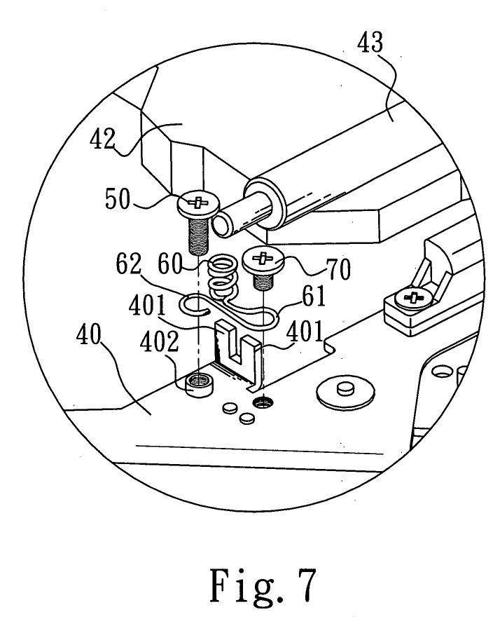

Please refer to FIG. 7. FIG. 7 is a partly enlarged exploded view showing the shaft adjusting device for an optical pickup unit according to a second preferred embodiment of the present invention.

As the figure shows, the structure of shaft adjusting device is similar to which shown in FIG. 5. The different is that the shaft adjusting device in this embodiment further comprises an auxiliary positioning structure. The auxiliary positioning structure is a second hook portion 62 further formed extendedly from the end of the first hook portion 61. The second hook portion 62 is hooked with the first locking element 50 or the sleeve 402 for fixing the spring 60 on the loader 40 more stably and preventing the spring 60 from being slid on the loader 40 under an uneven force pressed by the shaft 43.

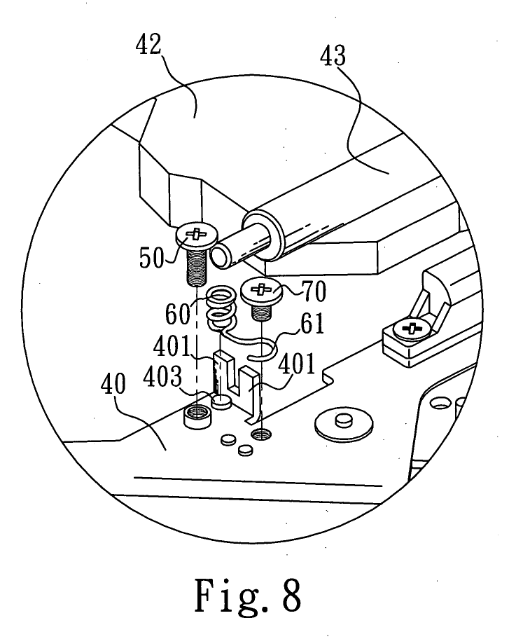

Finally, please refer to FIG. 8. FIG. 8 is a partly enlarged exploded view, showing a shaft adjusting device for an optical pickup unit according to a third preferred embodiment of the present invention.

As the figure shows, the structure of shaft adjusting device is similar to which shown in FIG. 5. The different is that the shaft adjusting device in this embodiment further comprises an auxiliary positioning structure. The auxiliary positioning structure in this embodiment is a raised block 403. The raised block 403 is integrated formed on the loader 40 near the end of the shaft 43; the outer diameter of the raised block 403 is matched with the inner diameter of the spring 60. The spring 60 is put around the raised block 403 to prevent the spring 60 from being slid on the loader 40 under the uneven force pressed by the shaft 43.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A shaft adjusting device for an optical pickup unit, which is installed on a loader of an optical disc drive and near one end of a shaft, said shaft adjusting device comprises:
a spring, fixed on said loader for supporting the end of said shaft and having a first hook portion extendedly formed from one end thereof;
a first locking element, disposed on said loader and clamping the end of said shaft with said spring; and
a second locking element, passing through said first hook portion and locked into said loader for fixing said spring on said loader.

2. The shaft adjusting device according to claim 1, wherein said first locking element is a screw.

3. The shaft adjusting device according to claim 1, wherein said second locking element is a screw.

4. The shaft adjusting device according to claim 1, which further comprises an auxiliary positioning structure for positioning said spring.

5. The shaft adjusting device according to claim 4, wherein said auxiliary positioning structure is a raised block disposed on said loader, and said spring is put around said raised block.

6. The shaft adjusting device according to claim 4, wherein said auxiliary positioning structure is a second hook portion formed extendedly from the end of said first hook portion of said spring, and said second hook portion is hooked with said first locking element.

7. The shaft adjusting device according to claim 1, which further comprises a sleeve provided on said loader for receiving said first locking element to be locked in and out.

8. The shaft adjusting device according to claim 7, wherein said spring has a second hook portion further formed extendedly from the end of said first hook portion, and said second hook portion is hooked around said sleeve.
